(19) United States
(12) Patent Application Publication
(10) Pub. No.: US 2026/0106953 A1
(43) Pub. Date: Apr. 16, 2026

(54) Remote Camera Stream System and Method

(71) Applicants: James Lucas, Appleton, WI (US); Richard Verbsky, Appleton, WI (US)

(72) Inventors: James Lucas, Appleton, WI (US); Richard Verbsky, Appleton, WI (US)

(21) Appl. No.: 18/915,350

(22) Filed: Oct. 14, 2024

(51) Int. Cl. H04N 7/18; H04N 23/661

(52) U.S. Cl. CPC H04N 7/183; H04N 23/661

(57) ABSTRACT

The invention relates to a system and method which include at least one camera with an input station connected to it along with a server are both connected to an internal network and an external network, wherein the input station, when activated causes the camera to alert a predetermined party as well as trigger the server to receive, convert, and transmit the camera's livestream in real-time/near real-time for viewing by users with only access to the external network.

### BACKGROUND OF THE INVENTION

In recent years, the increasing frequency of active shooter incidents, such as those in educational, government, and private business settings, has highlighted the urgent need for more effective tools and technologies to aid law enforcement in responding swiftly and effectively to such situations. Active shooter situations are often chaotic and rapidly evolving, requiring law enforcement personnel to make critical decisions under intense pressure; these decisions depend heavily on the available information to such personnel. Currently, when engaging with these situations, law enforcement personnel and support personnel often have little, if any, real-time information available to them regarding the activity and structural/logistical characteristics inside a building or location(s) where the event is occurring. While many schools have surveillance systems recording video and/or audio throughout the internal infrastructure of a building/location, this footage, much less real-time footage, is contained within an internal network within the school and unavailable to law enforcement and support staff without access to the internal network. This information, if known and accessible, could greatly enhance the speed of neutralization and reduce injury and loss of life by disclosing at least the location/real-time shooter and hostage/civilian activity, as well as building floorplans and camera locations. As active shooter situations continue to pose a significant threat to public safety, a solution which provides selective real-time (or near real-time) audio/video footage from surveillance cameras within an organization/school during an emergency situation is needed.

### SUMMARY OF THE INVENTION

An object of the invention is to provide a system where cameras connected to an internal network can selectively broadcast an audio/video stream (also called a livestream) to devices on an external network without providing access to the internal network.

Another object of the invention is to provide a method to provide floorplan information and streaming camera footage from cameras connected to an internal network to devices on an external network in real-time/near real-time.

### BRIEF DESCRIPTION OF DRAWINGS

FIG. 1 is a schematic view of an embodiment of the system;

FIG. 2 is a transactional diagrams illustrating an active event process; and

FIG. 3 is an illustrative example of a screenshot of an embodiment of streaming website 132 during an active event 200.

### DETAILED DESCRIPTION OF THE INVENTION

For the following defined terms, these definitions shall be applied, unless a different definition is given in the claims or elsewhere in this specification.

As used in this specification and the appended claims, if any, the singular forms “a”, “an”, and “the” include plural referents unless the content clearly dictates otherwise. As used in this specification and the appended claims, the term “or” is generally employed in its sense including “and/or” unless the content clearly dictates otherwise. It is to be noted that in order to facilitate understanding, certain features of the disclosure may be described in the singular, even though those features may be plural or recurring within the disclosed embodiment(s). Each instance of the features may include and/or be encompassed by the singular disclosure(s), unless expressly stated to the contrary.

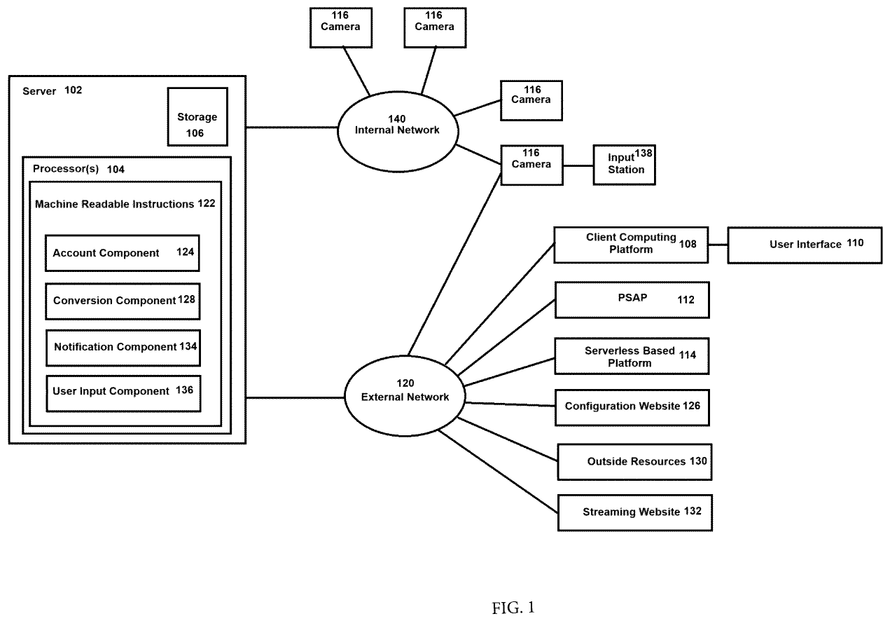

FIG. 1 illustrates a system 100 configured for facilitating the organization and management of selectively transmitting live stream of audio/video data from cameras connected to an internal organization network 140 (an LAN/intranet) from access by the public, often for example by a firewall, for viewing on a client computing platform 108 or website 132 (hosted on a website server or viewable via a content delivery network like AWS CloudFront or similar) via an external network 120 (such as the internet) in accordance with one or more embodiments/implementations. Server 102 is preferably connected to the internal network 140 via a network interface card and also to the external network 120 also via a network interface card, however other connection modalities such as direct integrated network interfaces, fiber optic interfaces, USB network adapters, modems wireless adapters, network appliances and gateways, InfiniBand, direct attach cables, Thunderbolt, etc. are contemplated. Normally, users without access to the internal network 140 of an organization would not be able to view information, such as video footage taken by cameras on the internal network 140, which greatly inhibits the ability of police and first responders to understand the movement and actions of individuals, such as active shooters and hostages, located within the organization during an event (as well as increases their risk of injury). By way of example, in some embodiments system 100 may comprise one or more servers 102 including one or more processors 104 and electronic storage 106, one or more client computing platforms 108, one or more user interfaces 110, one or more public safety answering point (PSAP) 112, one or more websites 132, one or more serverless computing platform 114 (such as Lambda from Amazon® Web Services), one or more cameras 116, one or more input stations 138, and/or other components. Server 102 is connected to camera(s) 116 via an internal network 140 and connected to client computing platform 108, user interface 110, PSAP 112, serverless computing platform 114, and website 132 via an outside/external network 120. The devices connected to the external network 120 do not have direct access to the audio/video stream from camera(s) 116 connected to the internal network 140 in real-time/near real-time (defined as less than 1 second delay). Server 102 may integrate into an internal network 140 as a part of virtually any video management system an organization has since server 102 is interacting purely with cameras 116 and is itself connected to external network 120.

Server 102 may be configured to connect and communicate with one or more camera(s) 116 on an internal network 140 of an organization via a hardwired/cable connection or wireless connection, wherein server 102 is configured to receive streaming audio and video data from camera(s) 116 in a format, preferably in real-time streaming protocol (RTSP) and converts said streaming data to a different format, preferably WebRTC and transmits said WebRTC formatted audio and video data to a client computing platform 108 and/or website 132 other platform/resource located on an external network 120 (internet) for display to a user via an user interface 110 according to a client/server design and/or other designs/architectures (such as via website 132 hosted on a website host or software application stored on, or providing access to, server 102).

This conversion is crucial for providing real-time/near real-time streaming to users on a plethora of user interfaces (as most web browsers support WebRTC) as RTSP is not widely supported. Further, most video management system apps use HTTP Live Streaming (HLS)/Dynamic Adaptive Streaming of HTTP (DASH) which although is scalable to a large quantity of users, has a 4-7 second delay, while the current system does not, it is less than one second delay, allowing users access to crucial audio/video (one or both) within an organization/building regardless of their user interface type (so client computing platform's 108 nor user interfaces 110 need to be preconfigured/pre-setup to view WebRTC streams from cameras 116). Server 102 may also be configured to communicate with at least one PSAP 112 and at least one serverless based platform 114 both connected to an external network 120. PSAP 112, serverless based platform 114, nor client computing platform 108 have direct access to the internal network 140. Users may interface with server 102 via a user interface 110 accessible through or included on a client computer platform(s) 108 via direct connection, internal network 140, or external network 120. It is further contemplated server 102 may further comprises at least one physical output relay to control/activate other equipment such as motors, electronics, etc. for locking, unlocking, or controlling access to an organization's building and infrastructure.

The users may include one or more PSAP, law enforcement, first responder, building, school, or other personnel/persons. For example, the users may include a first user, second user, third user, fourth user, and so on. Further, it is contemplated an individual user of one type may also be a user of a different type. For example, a law enforcement personnel user may also be a school personnel user.

Server 102 may be configured by machine-readable instructions 122. Machine-readable instructions 122 may include one or more instruction components. The instruction components may include computer program components. The instruction components may comprise one or more of the following: account component 124, configuration website 126, conversion component 128, notification component 134, user input component 136, and/or other instruction components.

Account component 124 may be configured to manage user accounts for users with access to server 102. Account component 124 may include information specific to a particular user, such as a contact list including a PSAP, message content to send to PSAP when an active event 200 begins and ends, and other entities when an active event is triggered, user location address, and other information.

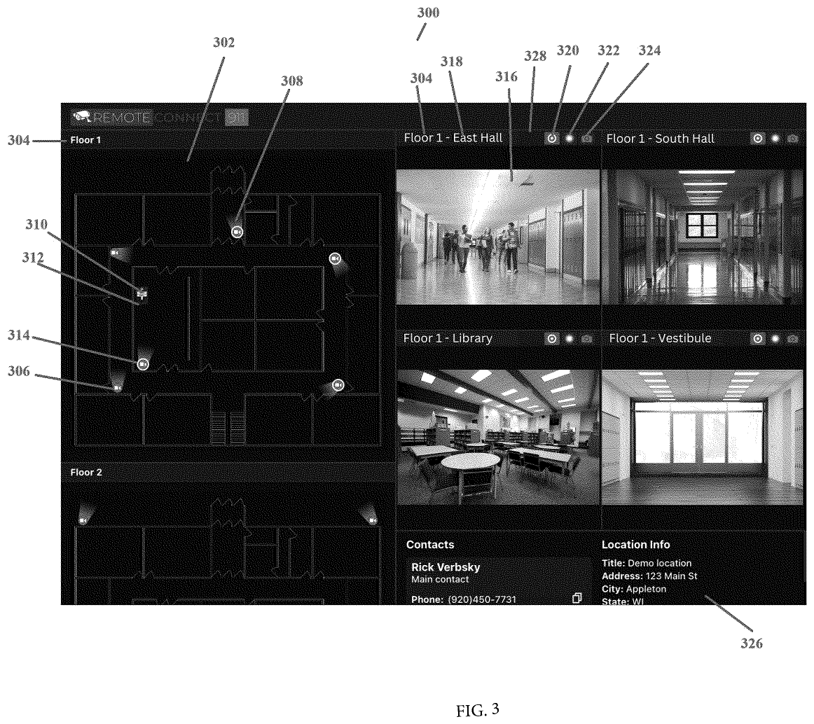

Configuration website 126 is hosted on a serverless platform or a server, such as a cloud based server and may be configured to comprise, receive, change, delete, and display information (such as images, see FIG. 3 for example) to a user (via user interface 110) pertaining to a floorplan for at least one floor of a building for display to a user viewing streaming website 132 (display location), such as a school; church; government; arena; commercial; or other building or property including details for each floor or space. Examples of details include, but are not limited to, the location and configuration of interior walls; exterior walls; room labels; doors; windows; room dimensions; wall lengths; furniture; fixtures; elevators; stairs; landscaping; scales; symbols; legends; and additional details. Configuration website 126 may further comprise, receive and display icons representing a camera 116 located on a floorplan indicating its location and viewing direction and scope as well as displaying an indication (via a visual indicator such as a highlight of the icon or color displayed around) if the audio/video stream of a camera 116 associated with the icon is also displayed to a user via streaming website 132. Further, configuration website 126 may be configured to allow a user to place/indicate (via an icon) a location of an input station 138 (also represented by an icon), and other items to indicate location within each floorplan as well as information about each floorplan, including but not limited to dimensions of the floorplan and components thereof, location, etc. Configuration website 126 may be configured to allow a user, such as a customer owner of a location, to login via account credentials to configuration website 126 and build, alter, or delete floorplans for their location and to also add/remove camera 116 locations and input stations 138 locations in each floorplan. Configuration website 126 for a customer is setup to display the floorplan along with camera 116 locations and input station 138 locations on a streaming website 132 along with live streams of at least one camera 116 during an active event 200. When there is no active event 200, no live stream from any camera 116 will be displayed on the associated streaming website 132. Floorplans and camera 116/input station 138 locations may be displayed, if desired, on streaming website 132 regardless of an active event 200 or not.

Conversion component 128 may be configured to receive an audio/video stream from each camera 116 on internal network 140 when an input station 138 is activated. Input station 138 may be an type of input, in the preferred embodiment it is a push/pull station which, when activated by a user physically pushing/pulling a level or button on the station which closes a circuit to allow a voltage and/or current to travel to an electronical input on camera 116 upon which camera 116 communicates with serverless based platform 114, triggering serverless based platform 114 to communicate with server 102 to activate conversion component 128 (if needed, this is due to variation in programming languages between camera 116 and server 102 as camera 116 can be configured to trigger serverless platform 114 to send an text message needed to any public IP address (sever 102)). Once activated, conversion component 128 begins converting the audio/video stream output from each camera 116 connected to internal network 140 (which is preferably transmitted from camera(s) 116 using RTSP but other formats at contemplated, such as RTMP, SRT, and other formats/protocols) into a WebRTC stream and then transmit this WebRTC stream to streaming website 132 via external network 120 for viewing by client computer platform 108 via user interface 110, thereby allowing users without access to internal network 140 to view each camera 116 stream in real-time or near real-time.

Conversion component 128 converts the stream received by server 102 using RTSP into WebRTC for retransmission frame/packet by frame/packet, by first receiving the RTSP stream from the RTSP client (each camera 116), decoding the RTSP stream using RTP demuxing/demultiplexing and decoding the media data of the stream, then re-encoding the media data using WebRTC specific codecs, like VP8, VP9, or H.264 for video, and Opus or G.711 for audio, and then setting up a WebRTC connection to the website 132 and transmitting the converted WebRTC stream for viewing in real-time/near real-time. Conversion component 128 may, but is not required to, use third party software run on server 102, if desired, to complete the RTSP to WebRTC conversion process.

While camera(s) 116 are always capturing, encoding, and streaming audio/video (using RTSP preferably), unless there is an active event 200, server 102 does not convert and transmit camera(s) 116 stream(s) over external network 120. During an active event 200, streaming audio/video of camera(s) 116, once converted to WebRTC is saved on server 102 in electronic storage 106 (preferably as separate files for each camera 116 stream) until active event 200 has ended by deactivated of the activated input station 138. Server 102 can save camera(s) 116 WebRTC stream during active event 200 in known audio/video formats like .MP4, .WMV, etc. Once active event 200 has ended, if server 102 has been configured to do so, server 102 will either retain saved streams of each camera 116 or will copy the saved streams to a cloud based platform (such as AWS S3 storage) for a specific user and may be configured to save an additional copy for PSAP or other user retrieval as desired.

Notification component 134 may be configured to generate and send notifications to a user. For example, notification component 134 may generate notifications relating to the start and end of an active event 200 (see description below) or the completion of, or an error associated with, an action or inaction of a component of server 102.

User Input Component 136 may be configured to receive one or more inputs from a user, generally through a user interface 110 (such as a web browser or software application) on a client computing platform 108. User Input Component 136 may be configured to assist communication (sending information or receiving information) between a user and system 100. In some embodiments client computing platform 108, user interface(s) 110, Serverless based platform 114, and/or outside resources 120 may be included as part of server 102.

Camera 116 is generally a network/internet connected CCTV camera that may be configured to send an audio/video stream to server 102 connected to an internal network 140, and also send communication such as an email (via SMTP for example), text (via SMS for example), or other communication protocols and notices to serverless based platform 114, PSAP 112, streaming website 132, and outside resources 130 located on an external network 120. One such example is Axis Communications, Inc. branded cameras Model No. P3265-V Dome Camera, but other camera manufacturers are contemplated. While server 102 may also perform the same communication and notice actions as camera 116, this may introduce a reduction in the speed at which the real-time audio/video streaming from camera(s) 116 can be transmitted and viewed via a streaming website 132. Server may utilize existing camera(s) 116 existing on an internal network 140 or may have dedicated camera(s) 116 as long as the camera(s) can send notifications (such as email) as well to a server 102 or serverless based platform 114. It is further contemplated a camera 116 could also be a smartphone camera controlled by a software application or Bluetooth®/WIFI body camera or microphone. In addition, it is important to note that if a camera 116 is connected to an input station 138, then camera 116 is also connected to external network 120 and configured to send, upon activation by the connected input station 138, a communication to desired parties, such as a PSAP as well as to send a communication to server 102, currently via a serverless platform 114 connected to external network 120. This particular camera may be configured to send information specific to an active event, such as, but not limited to, an indication an active event is occurring at a location as also a link to streaming website 132. If a camera 116 is not connected to an input station 138, then it only connected to internal network 140 and not external network 120.

Input Station 138 may be configured to allow a person to activate the station by a press or pull by a person, physically or virtually, and require a physical key, password, or other requirement to allow controlled access (certain approved persons such as building personnel or law enforcement) to deactivate the station once activated. Further, it is contemplated input station 138 could be a virtual button in a software application, or similar, if desired.

As depicted in FIG. 1, server 102, client computing platform 108, PSAP 112, serverless based platform 114, and outside resources 130 may be interconnected through various digital communication links, which may be established using networks (external network 120) like the internet or alternative network structures. It is important to emphasize that this description is not restrictive, as various embodiments covered by this disclosure could use different methods of connectivity.

User interface 110 can be designed to enable interaction between users and system 100, as well as between users and client computing platform 108. For instance, user interface 110 might offer a medium through which users can input information into or receive information from system 100. Examples of user interface 110 implementations may comprise of one or more software applications (such as a web browser) and/or physical compositions such as display screens, touchscreens, monitors, keyboards, buttons, switches, knobs, levers, mice, microphones, voice command sensors, body movement sensors, hand and/or finger gesture sensors, and/or other devices intended to accept and/or transmit user input and may be hardware and/or software. In certain implementations, one or more user interfaces 110 may be integrated into one or more client computing platforms 108.

Each client computing platform 108 may incorporate several processors capable of running software modules that enable a user associated with client computing platform 108 to interact with system 100 and outside resources 120, along with performing other roles described in this specification to the client computing platform(s) 108. Examples of such platforms 108 include, but are not limited to, desktops, laptops, handhelds, tablets, smartphones, and/or other computer platforms.

Outside resources 120 can comprise of information sources or active entities outside to system 100, engaging with or participating within system 100. In certain cases, the roles typically associated with outside resources 120 might instead be managed internally within system 100.

Servers 102 are equipped with electronic storage 106 and one or more processors 104, among other elements as desired. These servers are designed with communication interfaces to facilitate the exchange of information transmitted from camera(s) 116 connected to an internal network 140 with parties connected to an external network 120 (but not the internal network 140) including, but not limited to, a client computing platform 108, PSAP 112, website 132, and one or more serverless based platforms 114. The portrayal of server 102 in FIG. 1 serves as an example and is not intended to be restrictive; server 102 could be realized through a networked cloud of computing platforms that collectively deliver the functionalities described for server 102.

Electronic storage 106 includes media that retain information in a non-transitory manner. This storage might be part of the server 102 hardware or connected externally through ports or drives. It might include various forms such as optical, magnetic, solid-state, and charge-based media, including cloud-based and other virtual storage solutions. This electronic storage is crucial for storing software, settings, processed and incoming data to/from camera(s) 116 and client computing platforms 108, and other data critical to the operational efficacy of server 102.

Processor(s) 104 are tailored to manage data processing tasks within server 102. They could include diverse processing entities like digital or analog processors, specialized circuits, quantum, or state machines. While represented as a single unit in FIG. 1 for simplicity, processor(s) 104 could encompass multiple processing elements either contained within a single physical unit or distributed across multiple units. These processors are responsible for executing various specified components (account component 124, conversion component 128, notification component 134, user input component 136, and other components) through different means such as software, hardware, or firmware, which may enhance the processing capacity of server 102.

Furthermore, it is important to understand that although the components such as accounting component 124, conversion component 127, notification component 134, and user input component 136, are depicted within a single unit in FIG. 1, in systems where processor(s) 104 comprises multiple units, these components could be configured separately or in combination at different locations. The functionality of these components as described is for illustration; they are adaptable, with possibilities for integration, modification, or omission, with their functions redistributed among other components as needed. This modular approach allows processor(s) 104 to potentially accommodate additional components that may undertake some or all of the tasks currently attributed to the existing components. It is also contemplated that at least server 102 (or one or more components thereof) and one or more camera 116 may be combined into a single unit and are not required to be separate devices.

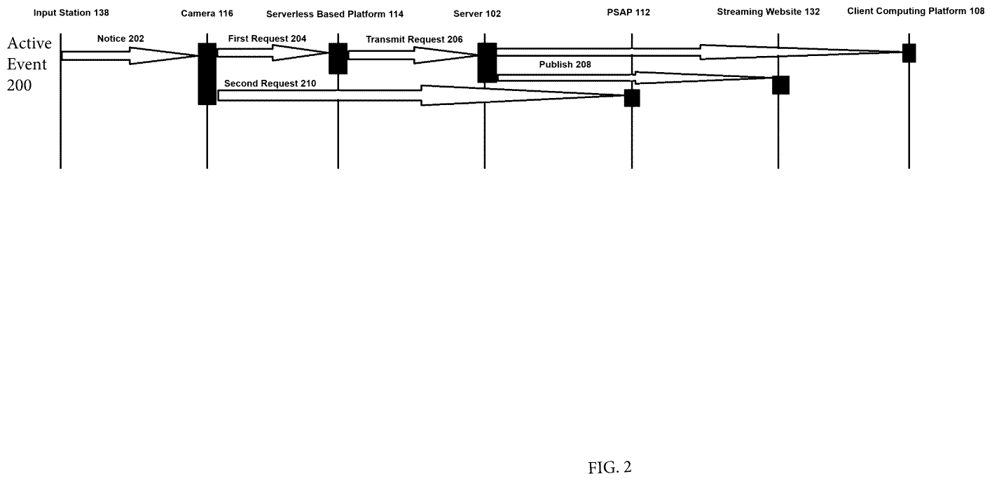

Turning to FIG. 2, a non-limiting example transactional diagram 10 illustrates an active event 200, which causes system 100 to start displaying the audio/video stream from camera(s) 116 in real-time/near real-time to individuals without access to internal network 140 via user interface 110 via streaming website 132. Active event 200 begins when input station 138 (which is connected to at least a camera 116) is activated by an individual, usually by physically activating the station, giving a notice 202 to camera 116 (via an electrical signal in the current embodiment). Camera 116, once detecting notice 202 then initiates at least two actions: (1) a first request 204 that sends a request to server 102 (via serverless based platform 114) to initiate conversion and publication of the stream from each camera 116 to streaming website 132 (or a software application); and (2) a second request 210 sends a communication to the PSAP 112 (and anyone else on a pre-created contact list) including at least a notice that an emergency event is occurring at the geographic location/address of camera 116, and the website address of the website 132 where a livestream from each camera 116 connected to server 102 can presently be viewed by the PSAP 112 (and anyone they share the website address for streaming website 132 with). Camera 116 may also be configured to send an audio/video clip of a duration along with the communication to the PSAP 112 and contact list. In the current embodiment a 15 second clip is preferable with the first 5 seconds being audio/video captured by the camera 116 connected to the activated input station 138 before input station 138 activation and the remaining 10 seconds being after input station 138 activation (the clip duration and pre/post activation segments are desirable for the PSAP to assist in quick determination of a false active event 200 or not). Camera 116 may send a communication/request through any manner known in the art, such as email (through an email server), SMS (text), MMS, SIP, VoIP, etc.

Once serverless based platform 114 is contacted via first action 204, transmits a transmit request 206 to server 102 to initiate receiving and conversion of the stream of each camera 116 to WebRTC format (via conversion component 128) and to publish 208/make available for viewing by users without access to internal network 140 each WebRTC stream on streaming website 132 and/or client computing platform 108 for viewing as long as the active event 200 is occurring (while input station 138 is activated). An active event 200 will occur anytime an input station 138 is activated but it is contemplated to occur during an emergency situations, such as an active shooter event, where individuals located outside the physical location of the event and internal network 140. It is contemplated system 100 may be configured so that camera(s) 116 sends a request directly to server 102 to begin receiving and converting camera 116 streams on internal network 140 from RTSP to WebRTC and to then publish the converted streams to streaming website 132, thereby bypassing a need for serverless based platform 114.

Once activated, an input station 138 can only be deactivated by an individual with the appropriate key, password, or other access credential. Once input station 138 is deactivated the camera 116 connected to input station 138 is configured to send a notice 202 to serverless based platform 114 which causes platform 114 to send a transmit request 206 to server 102 to stop RTSP to WebRTC conversion and stop transmission of each converted camera 116 audio/video stream to streaming website 132 and/or client platform 108. In addition, camera 116 connected to input station 138 also sends a second request 210 to PSAP 112 communicating the active event 200 is now inactive. This process ensures privacy and only allows users/viewers external to an organization and the internal network 140 to view livestreams of each camera 116 during an active event 200.

Turning to FIG. 3, an illustrative example of an embodiment 300 of streaming website 132 during an active event 200 that is viewable via user interface 110 is shown. User interface embodiment 300 comprises a plan view of a floorplan 302 for at least one floor in a building or location where camera(s) 116 are located. Each floorplan 302 comprises a title/identifier 304 for the specific floor as well as a camera identifier 306 (in the present embodiment an image of a red circle with a white camera icon in the middle) representing the location of each camera 116 on the given floor. Each camera identifier 306 further comprises a viewing angle identifier 308 (a blue cone shape in the current embodiment) indicating the direction and general viewing angle of a particular camera 116 to give users an orientation for viewing the livestream of the camera for strategic planning and engagement purposes in order to quickly and efficiently pacify any aggressors prompting the active event 200. Further, an active viewing indication 314 (such as an image of a white circle) will be displayed around a camera identifier 306 if the camera 116 said identifier 306 represents has a livestream presently viewable in user interface 300 (which will be discussed shortly). It is contemplated other views could be available such as elevational views or 3D floorplan viewing.

Each floorplan 302 further comprises an input station identifier 310 (in the present embodiment an image of a blue square) representing the location of each input station 138 located within the given floorplan and may also include an active station identifier 312 (such as an image of a white rectangle) displayed around the input station identifier 310 if the input station 138 represented by said identifier 310 is active/initiated the present active event 200. If there are more floorplans 302 than available viewable space, each floorplan 302 may be made available for viewing in a convenient manner, such as through a vertical or horizontal scrolling function or through multiple page views. Each floorplan 302 and each camera 116 and input station 138 location is setup during the initial installation of system 100 or when desired through configuration website 126.

User interface embodiment 300 further comprises at least one viewing window 328 which further comprises a camera live view 316 which comprises the viewable (by a user) livestream of a camera 116 via user interface 110 on a client computing platform 108 with a codec configured to work with WebRTC format. Viewing window 328 further comprises a floor title/identifier 304, a camera title 318 (which may indicate its location within a room), a camera active indication button 320, a camera blur button 322, and a camera snapshot button 324. The camera active indication button 320, when clicked, will cause a viewable indication (such as an image or animation) around the corresponding camera identifier 306 to the camera live view 316 to inform a user/viewer the location of the view 316. The camera blur button 322, which clicked, will cause the camera live view 316 to blur, which can be helpful to an user/viewer trying to focus on a single live view 316 if there are multiple camera live views 316 active in the user interface embodiment 300 at the same time. Last, the camera snapshot button 324, which clicked, will save a still image of the camera live view 316 (presently in a. JPG format, but other formats may be utilized) to a location/folder on the client computing platform 108 for forwarding by a user as desired. In the current embodiment 300 four viewing windows 328 may be viewed simultaneously, but other configurations are contemplated which may be dependent on the characteristics of client computing platform 108. If a different camera 116 live view 316 is desired to be viewed, a user may click on the desired camera identifier 306 in floorplan 302 to display its viewing window 328 and live view 316. User interface embodiment may also comprise an information panel 326 displayed information to a user/viewer such as building location information, contact information, or other information. Embodiment 300 is designed to allow a PSAP and law enforcement/first responders to easily and quickly access crucial information during emergency high stress timeframes without having a cumbersome process setup and software ahead of time. Further, each user interface 110 interacting with streaming website 132 views an independent of instance streaming website 132. That is, a first user viewing streaming website 132 on their user interface 110 may have a specific floorplan 302 user's choice of viewing windows 328/live views 316 shown while a second user viewing streaming website 132 on the second user's user interface 110 may have a different floorplan chosen (assuming there are multiple floorplans available for a location during an active event 200) and/or may have different camera 116 viewing windows from the first user.

While the present invention has been described above in terms of specific embodiments, it is to be understood that the invention is not limited to these disclosed embodiments. Many modifications and other embodiments of the invention will come to mind of those skilled in the art to which this invention pertain, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings. Likewise, where this document refers to technologies that would be apparent or known to one of ordinary skill in the art, such technologies encompass those apparent or known to the skilled artisan now or at any time in the future.

Amazon® is a federally registered trademark of Amazon Technologies, Inc., Seattle, WA. Bluetooth® is a federally registered trademark owned by Bluetooth SIG, INC., Kirkland, WA.

1. A system configured to transmit livestream camera footage, the system comprising:
At least one camera connected to a network configured to have a firewall, the at least one camera connected to the network inside the firewall;
At least one input station connected to the at least one camera inside the firewall;
A server connected to the network inside the firewall and connected to a network outside the firewall;
Wherein the server is configured to retrieve a livestream from the at least one camera in a first format, convert the first format into a second format different from the first format, and transmit the livestream in second format to the network outside the firewall when the at least one input station is activated.

2. The system of claim 1, wherein the at least one camera is further configured, when input station is activated, to transmit to a first party a clip of its livestream starting at a first time occurring before the input station was activated and continuing until a second time occurring after the input station was activated.

3. The system of claim 2, wherein the first party is a public safety answer point.

4. The system of claim 2, wherein the first time is five seconds before the input station is activated and the second time is ten seconds after the input station was activated.

5. The system of claim 1, wherein the at least one camera is a CCTV camera.

6. The system of claim 1, wherein the second format is WebRTC.

7. A method for livestreaming comprising the steps of:
Activating an input station connected to a camera;
The camera causing a server to start a first process and also communicating with a first party a clip of the livestream that is a first duration; and
The server starting the first process including the steps of receiving the livestream of the camera, performing a RTSP to WebRTC conversion on the livestream, and transmitting the converted livestream to a display location.

8. The method of claim 7 further comprising the steps of:
The server stopping RTSP to WebRTC conversion of the livestream and stopping transmission of the converted livestream to the display location when the input station is deactivated.

9. The method of claim 7, wherein the display location is a website.

10. The method of claim 7, wherein the first party is a public safety answer point.

11. A system configured to transmit livestream camera footage, the system comprising:
at least one camera;
at least one input station connected to the at least one camera;
a first server with one or more hardware processors configured by machine-readable instructions to connect to the at least one camera, receive its livestream, convert the livestream for viewing in real-time or near real-time on a web browser or software application, and transmitting the converted livestream to a second server,
wherein the at least one camera connected to at the at least one input station is configured, when the input station is activated, to direct the server to connect to the at least one camera, receive its livestream, convert its livestream from the first format to the second format, and to transmit the second format livestream to the second server until the at least one input station is deactivated.

12. The system of claim 11, wherein the second server is a website host.

13. The system of claim 11, wherein the second server is configured to operate with a software application operating on a client computing platform.

14. The system of claim 11, wherein the system further comprises at least one camera not connected to an input station.

15. The system of claim 11, wherein the first server and the at least one camera connected to the input station is connected to an internal network and to an external network.

16. The system of claim 11, wherein the first server saves a recording of the converted livestream.
